(19) United States
(12) Patent Application Publication
(10) Pub. No.: US 2014/0297221 A1
(43) Pub. Date: Oct. 2, 2014

(54) LOCATING SYSTEM AND LOCATING METHOD USING PRESSURE SENSOR

(71) Applicant: HON HAI PRECISION INDUSTRY CO., LTD., New Taipei (TW)

(72) Inventors: SHIH-CHENG WANG, New Taipei (TW); YI-WEN CAI, New Taipei (TW)

(73) Assignee: HON HAI PRECISION INDUSTRY CO., LTD., New Taipei (TW)

(21) Appl. No.: 14/214,093

(22) Filed: Mar. 14, 2014

(30) Foreign Application Priority Data
Mar. 27, 2013 (TW) 102110841

(51) Int. Cl. G01C 21/00; G01B 5/14

(52) U.S. Cl. CPC G01C 21/00; G01B 5/14
USPC 702/150

(57) ABSTRACT

A locating system includes a plurality of pressure sensors, a storage unit, and an analysis unit. The pressure sensors are located at different locations under a floor of a room to sense pressures. Each pressure sensor has a sensor identification (ID). The storage unit stores a location of each pressure sensor to correspond to the sensor ID of each pressure sensor. When a pressure sensor senses a pressure from a user, the analysis unit determines where the user is located in the room according to the location stored in the storage unit corresponding to the sensor ID of the pressure sensor.

### BACKGROUND

1. Technical Field

Embodiments of the present disclosure relate to locating technologies, and particularly, to a locating system and a locating method using pressure sensors.

2. Description of Related Art

Image analysis technologies are widely used in different situations. For example, in a particular region (e.g., a building or an indoor environment), a camera is installed to capture environment images and the captured images are analyzed to determine whether there are people in particular regions within the area of the captured images For example, the images may be analyzed to determine whether an object include features of hands, feet, and head. However, in some situations such as when there is a fire, the image analysis method may not work because of smoke, which means that if people are/were in the fire region they may not be rescued in time. Therefore, there is room for improvement in the art.

### BRIEF DESCRIPTION OF THE DRAWINGS

FIG. 1 shows a schematic block diagram of one embodiment of a locating system.

FIG. 2 is a schematic diagram of a curve graph of a sensing signal sensed by a pressure sensor of FIG. 1.

FIG. 3 shows a schematic diagram of distribution of pressure sensors of the locating system of FIG. 1.

FIG. 4 is a flowchart of one embodiment of a locating method implemented by the locating system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

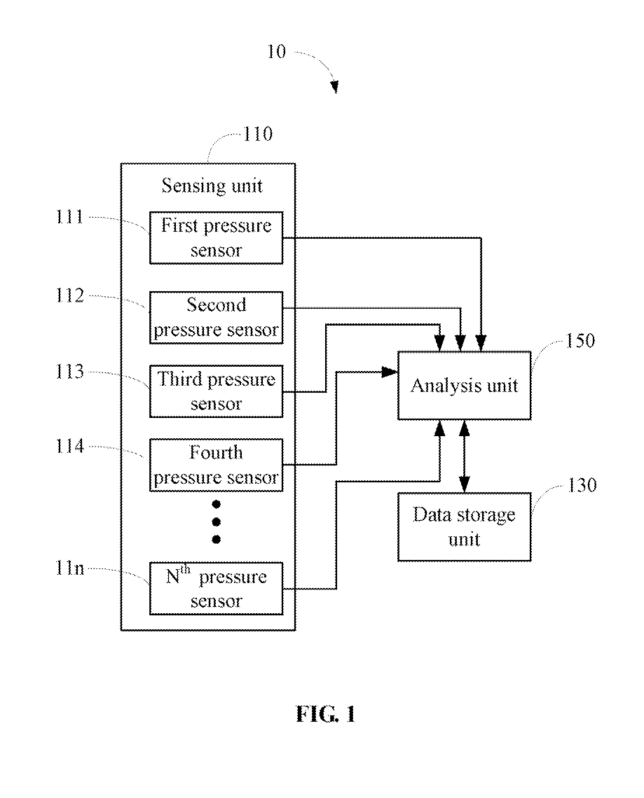

FIG. 1 shows a schematic block diagram of one embodiment of a locating system 10. The locating system 10 includes a sensing unit 110, a data storage unit 130, and a analysis unit 150. The sensing unit 110 communicates with the analysis unit 150 via a wired connection or a wireless connection to exchange or transmit data. The data storage unit 130 is connected to the analysis unit 150 via a data bus. In other embodiments, the data storage unit 130 can be integrated in the analysis unit 150.

The sensing unit 110 includes a plurality of pressure sensors, such as a first pressure sensor 111, a second pressure sensor 112, a third pressure sensor 113, a fourth pressure sensor 114, . . . , and an N^{th} pressure sensor 11n. The plurality of pressure sensors are respectively located at different locations under a floor of a room (e.g., an indoor environment or a building), to sense pressure on the different locations of the floor from different objects.

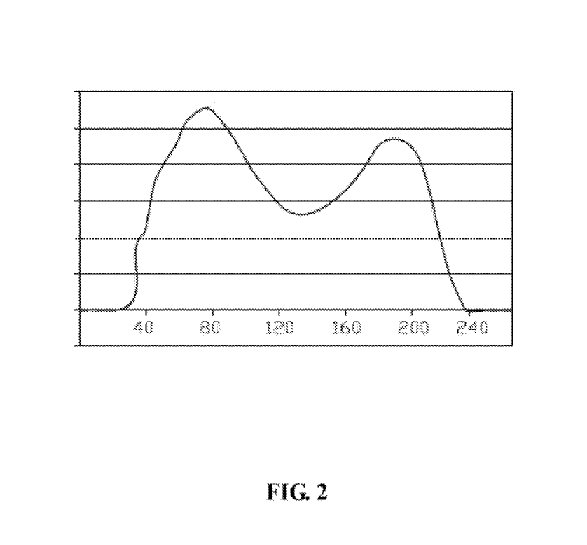

FIG. 2 is a waveform of an electrical signal (e.g., voltage signal) outputted by a pressure sensor according to a sensed pressure. The electrical signal is transmitted to the analysis unit 150 for analyzing. In this embodiment, the electrical signal may be an indication of a value of the sensed pressure. The waveform of the electrical signal shows a change of the pressure sensed by the pressure sensor, which can be used to analyze a footstep profile feature of a user walking on the pressure sensor.

In the embodiment, each of the plurality of pressure sensors has a sensor identification (ID) stored in the data storage unit 130. The storage unit 130 further stores a location of each pressure sensor to correspond to the sensor ID of each pressure sensor. In addition, the storage unit 130 stores templates of a plurality of footstep profile features of different people. The plurality of templates of footstep profile features can be pre-gathered by analyzing electrical signals generated by a pressure sensor when each person walks on the pressure sensor. For example, when a person walks on the pressure sensor, the pressure sensor may generate an electrical signal. Then, a wave form of the electrical signal is generated. Any combination of features of the wave form can be the footstep profile feature template of the person. For example, the features of the wave form can include a pattern, a length, peaks and valleys of the wave form. In addition, the templates stored in the storage unit 130 can be updated according to requirements, for example, when some people got fat.

When a pressure sensor senses pressure, the pressure sensor generates an electrical signal and sends the electrical signal and the sensor ID of the pressure sensor to the analysis unit 150. The analysis unit 150 first determines where the user is located in the room according to the sensor ID sent from the pressure sensor. Then, the analysis unit 150 extracts a footstep profile feature of the user according to a waveform of the electrical signal, and determines an identity of the user by comparing the extracted footstep profile feature with the templates of the plurality of footstep profile features of the different people stored in the storage unit 130.

When two or more pressure sensors sense pressure at different times, the analysis unit 150 records time information when the electrical signal is sent from each of the two or more sensors and then determines a walking path and a walking direction of the user in the room according to the recorded time information and the location of each of the two or more sensors.

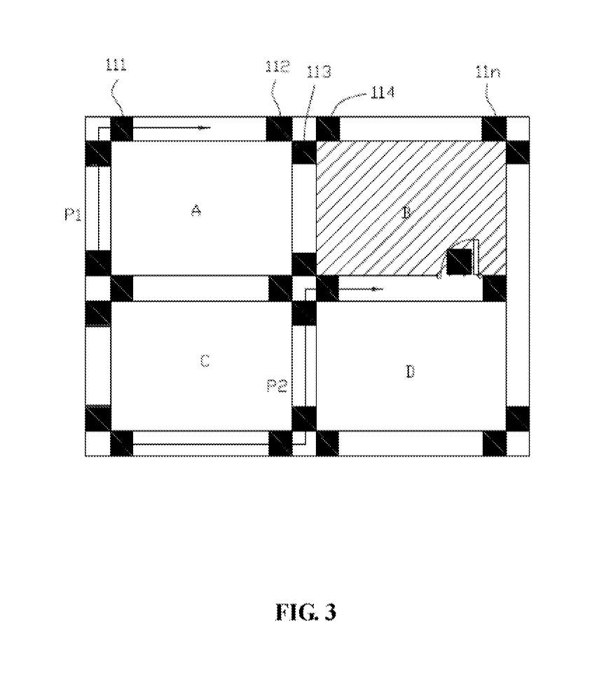

FIG. 3 shows a schematic diagram of distribution of pressure sensors in the room. Each of the pressure sensors is located at a predetermined position of the room, such as entries and exits of the room. When the analysis unit 150 determines that the walking path of the user is “P1”, the user is determined to be within a region “A” of the room. When the analysis unit 150 determines that the walking path of the user is “P2”, the user is determined to be within a region “B” of the room.

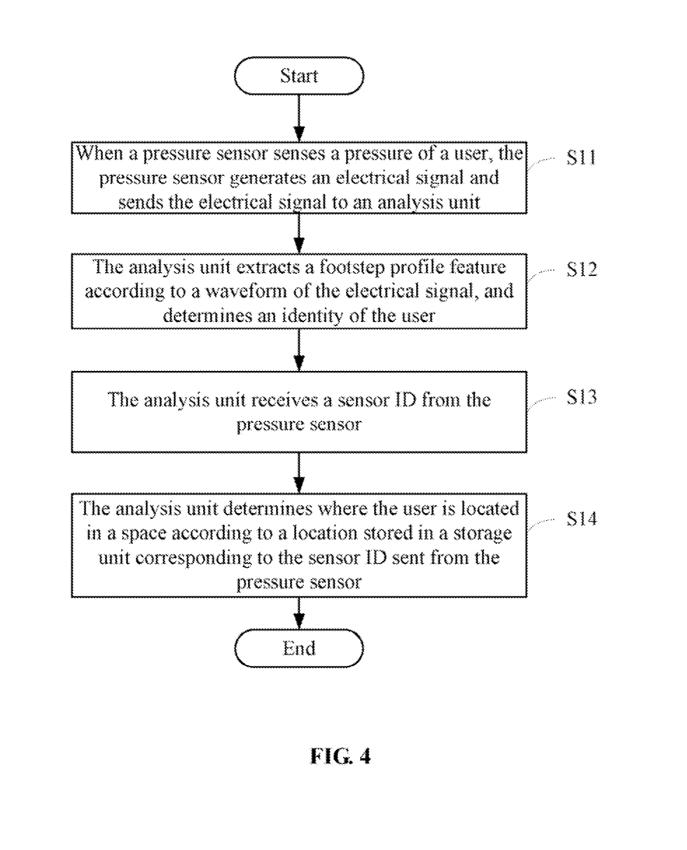

FIG. 4 is a flowchart of one embodiment of a locating method implemented by the locating system 10 of FIG. 1. Depending on the embodiment, additional steps may be added, others removed, and the ordering of the steps may be changed.

In step S11, When a pressure sensor senses a pressure, an electrical signal is generated and sent to the analysis unit 150.

In step S12, the analysis unit 150 extracts a footstep profile feature according to a waveform of the electrical signal, and determines an identity of the user by comparing the extracted footstep profile feature with the templates of the plurality of footstep profile features of the different people stored in the storage unit 130.

In step S13, the analysis unit 150 receives the sensor ID sent from the pressure sensor.

In step S14, the analysis unit 150 determines where the user is located in the room according to the location stored in the storage unit 130 corresponding to the sensor ID sent from the pressure sensor.

As described above, the LOCATING SYSTEM 10 can easily find a location of the user in an area using a plurality of pressure sensors.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A locating system, comprising:
a plurality of pressure sensors located at different locations under a floor of a room to sense pressures, each pressure sensor having a sensor identification (ID);
a storage unit storing a location of each pressure sensor corresponding to the sensor ID of each pressure sensor; and
an analysis unit determining where a user is located in the room according to the location stored in the storage unit corresponding to the sensor ID of a pressure sensor when the pressure sensor senses a pressure from the user.

2. The locating system according to claim 1, wherein each of the plurality of pressure sensors generates an electrical signal when the pressure is sensed, the electrical signal is an indication of a value of the sensed pressure.

3. The locating system according to claim 2, wherein the storage unit further stores templates of a plurality of footstep profile features of different people.

4. The locating system according to claim 3, wherein the analysis unit further receives the electrical signal sent from the pressure sensor, extracts a footstep profile feature according to a waveform of the electrical signal, and determines an identity of the user by comparing the extracted footstep profile feature with the templates of the plurality of footstep profile features of the different people.

5. The locating system according to claim 4, wherein the wave form of the electrical signal shows a change of the pressure sensed by the pressure sensor.

6. The locating system according to claim 2, wherein when two or more pressure sensors sense pressure at different time, the analysis unit further records time information when the electrical signal is sent from each of the two or more sensors and determines a walking path and a walking direction of the user in the room according to the recorded time information and the location of each of the two or more sensors.

7. The locating system according to claim 2, wherein the electrical signal is a voltage signal.

8. A locating method, comprising:
sensing a pressure from a user using a plurality of pressure sensors located at different locations under a floor of a room, each pressure sensor having a sensor identification (ID);
storing a location of each pressure sensor to correspond to the sensor ID of each pressure sensor in a storage unit; and
determining where the user is located in the room according to the location stored in the storage unit corresponding to the sensor ID of a pressure sensor when the pressure sensor senses the pressure from the user.

9. The method according to claim 8, wherein each of the plurality of pressure sensors generates an electrical signal when the pressure from the user is sensed, the electrical signal is an indication of a value of the sensed pressure.

10. The method according to claim 9, further comprising:
storing templates of a plurality of footstep profile features of different people in the storage unit.

11. The method according to claim 10, further comprising:
receiving the electrical signal sent from the pressure sensor;
extracting a footstep profile feature of the user according to a waveform of the electrical signal; and
determining an identity of the user by comparing the extracted footstep profile feature with the templates of the plurality of footstep profile features of the different people.

12. The method according to claim 11, wherein the wave form of the electrical signal shows a change of the pressure sensed by the pressure sensor.

13. The method according to claim 9, further comprising:
in response to two or more pressure sensors sensing pressure at different time, recording time information when the electrical signal is sent from each of the two or more sensors and determining a walking path and a walking direction of the user in the room according to the recorded time information and the location of each of the two or more sensors.

14. The method according to claim 9, wherein the electrical signal is a voltage signal.
